(19) United States
(12) Patent Application Publication
(10) Pub. No.: US 2006/0028984 A1
(43) Pub. Date: Feb. 9, 2006

(54) Energy efficient medium access control protocol for IEEE 802.11 WLANs

(75) Inventors: Shih-Lin Wu, Taoyuan County (TW); Pao-Chu Tseng, Pingjhen City (TW)

Correspondence Address: NIKOLAI & MERSEREAU, P.A., 900 SECOND AVENUE SOUTH, SUITE 820, MINNEAPOLIS, MN, 55402, US

(73) Assignee: CHANG GUNG UNIVERSITY, Tao-Yuan (TW)

(21) Appl. No.: 10/914,324

(22) Filed: Aug. 9, 2004

(51) Int. Cl. H04L 12/26; H04B 7/005; H04Q 7/00

(52) U.S. Cl. 370/230; 370/329; 370/278

(57) ABSTRACT

IEEE 802.11 power management scheme for an ad hoc network is based on the Carrier Sense Multiple Access with Collision Avoidance (CSMA/CA) access procedure to transmit/receive their data frames. CSMA/CA may waste the scarce energy and bandwidth due to frame collisions and lengthen the frame delay due to waiting backoff time. In addition, IEEE 802.11 power management scheme does not specify how to tune the ATIM window size in a beacon interval. However, the ATIM window size affects the power consumption and throughput of a network considerably. The fixed ATIM window size cannot always accommodate the various traffic conditions. To conquer these problems and to improve the performance of networks, we propose a energy efficient MAC protocol for IEEE 802.11 networks by scheduling transmission after the ATIM window and adjusting the ATIM window dynamically to adapt to the traffic status.

### BACKGROUND OF THE INVENTION

1. Field of the Invention

The present invention relates to an energy efficient medium access control (MAC) protocol, and more particularly to an energy efficient (MAC) protocol for IEEE 802.11 WLANs.

2. Description of Related Art

More and more people have data access through hand-held wireless devices anytime, anywhere. To support mobility, most hand-held wireless devices are powered by batteries that have only a limited amount of energy. Therefore, energy efficiency becomes one of the most important design issues in mobile wireless networks. In the recent years, a lot of papers discuss various methods to reduce energy consumption and can be classified into medium access control (MAC) [reference 3, 6, 7 and 14], routing [reference 11 and 12], and transport protocols [reference 1, 8, 9 and 17]. Woesner et al. [reference 15] has pointed out that MAC protocol could significantly reduce the power consumption of mobile devices. Therefore, this paper focus on the energy conserving of MAC protocol for wireless LANs (WLANs).

IEEE 802.11 standard [reference 16] has specified the MAC protocol including distributed coordination function (DOF), a distributed mechanism, and point coordination function (PCF), a centralized mechanism. It also provides two different power management schemes: one for infrastruture and the other for ad hoc network. Our energy efficient mechanism is proposed for IEEE 802.11 ad hoc WLANs. In IEEE 802.11 protocol, wireless nodes have two power modes: active and power saving (PS). The power management scheme divides time into beacon intervals. At the beginning of each beacon interval, power saving nodes wake up for a short time period, called announcement traffic indication message (ATIM) window. In the ATIM window, nodes exchange control frames to inform their power saving counterparts to keep awake until the end of the beacon interval for receiving their data frame. After ATIM window, all nodes follow DCF protocol to transmit their data frames. Feeney et al. [reference 4] points out that DCF is based on the Carrier Sense Multiple Access with Collision Avoidance (CSMA/CA) so it may waste scarce energy and bandwidth due to frame collisions and lengthen the frame delay due to waiting backoff time.

There are a lot of researches take the advantage of transmission scheduling to avoid frame collisions and improve channel utilization. However, most scheduling algorithms [reference 13, 2 and 10] are designed for centralized or master-driven system or even for distributed systems they cannot avoid medium contention and backoff time delay [reference 6]. We observe that nodes operating in IEEE 802.11 power saving protocol will wake up in an ATIM window so that all nodes can overhear each ATIM frame in the short period and then calculate the duration of each to-be-transmitted data frame after the ATIM window in a single-hop ad hoc network. According to the phenomenon, we propose an efficient scheduling protocol to prevent PS nodes from contending medium again after ATIM window with no extra overhead.

IEEE 802.11 power management scheme does not specify how to tune the ATIM window size in a beacon interval. However, Woesner et al. [reference 15] has pointed out that the fixed ATIM window size cannot reach the optimal throughput. Therefore, the other design issue is the ATIM window size which affects the power consumption and throughput of a network considerably. Jung et al. [reference 7] designed a mechanism to dynamically choose an ATIM window size to improve network throughput, but it has some overhead and limitation, and it does not support scheduling. Thus, we propose a novel strategy that can adjust the ATIM window size dynamically according to the constantly varying traffic load.

In sum, this paper makes two contributions to the energy efficiency in WLANs. First, an efficient scheduling transmission protocol is proposed to avoid PS nodes contending medium again after the ATIM window without any extra overhead. Second, we propose a novel strategy to dynamically adjust the ATIM window size to accommodate to various traffic conditions for improving network throughput and reducing PS nodes' power consumption.

### SUMMARY OF THE INVENTION

A good design of MAC protocols should realize both minimum energy consumption as well as maximum data throughput. IEEE 802.11 power management scheme for an ad hoc network is based on the Carrier Sense Multiple Access with. Collision Avoidance (CSMA/CA) access procedure to transmit/receive their data frames. CSMA/CA may waste the scarce energy and bandwidth due to frame collisions and lengthen the frame delay due to waiting backoff time. In addition, IEEE 802.11 power management scheme does not specify how to tune the ATIM window size in a beacon interval. However, the ATIM window size affects the power consumption and throughput of a network considerably. The fixed ATIM window size cannot always accommodate the various traffic conditions. To conquer these problems and to improve the performance of networks, we propose an energy efficient MAC protocol for IEEE 802.11 networks by scheduling transmission after the ATIM window and adjusting the ATIM window dynamically to adapt to the traffic status. Simulation results show that our protocol attains the better energy efficiency as well as throughput than existing protocols.

Further benefits and advantages of the present invention will become apparent after a careful reading of the detailed description with appropriate reference to the accompanying drawings.

### BRIEF DESCRIPTION OF THE DRAWINGS

FIG. 1 is an example of IEEE 802.11 power management scheme in ad hoc network.

FIG. 2 is an example of scheduling protocol.

FIG. 3 is the first ATIM period ending rule. If nodes sense the channel being idle T_{DIFS}+T_{Cwmin}, nodes end ATIM window at once.

FIG. 4 is the second ATIM period ending rule. After calculating, if the remaining beacon interval is less than T_{ATIM}+3T_{SIFS}+T_{FRAMEmin}+2T_{ACK}, nodes end ATIM window at once.

FIG. 5: (a) total data frames delivered per joule (Kbyte/Joule) by all nodes in the simulation; (b) total data frames delivered per joule (Kbyte/Joule) by PS nodes only in the simulation.

FIG. 6: (a) total data frames delivered per second (Kbyte/sec) by all nodes in the simulation; (b) total data frames delivered per second (Kbyte/sec) by PS nodes only in the simulation.

FIG. 7 shows the relation between traffic load and the collision times of ATIM frames.

FIG. 8 shows the packets sending from PS and active nodes.

### DETAILED DESCRIPTION OF THE INVENTION

In the network, all nodes are fully connected and time synchronization, so that all PS nodes wake up at almost the same TBTT (Target Beacon Transmission Time) at each beacon interval. At each TBTT, each node contends to send a beacon for time synchronization with each other and wakes up for the rest of the ATIM window. If a node with buffering unicast frames to PS nodes, it will send an ATIM frame to the PS nodes within the ATIM window period. On receiving the ATIM frame, the PS node responses an ATIM ACK and both the sender and receiver will keep awake for the whole beacon interval. After the end of ATIM window, all nodes follow the normal DCF access procedure to transmit their data frame. To let PS nodes with higher priority, only beacon, ACK, RTS, and ATIM frame can be send in the ATIM window.

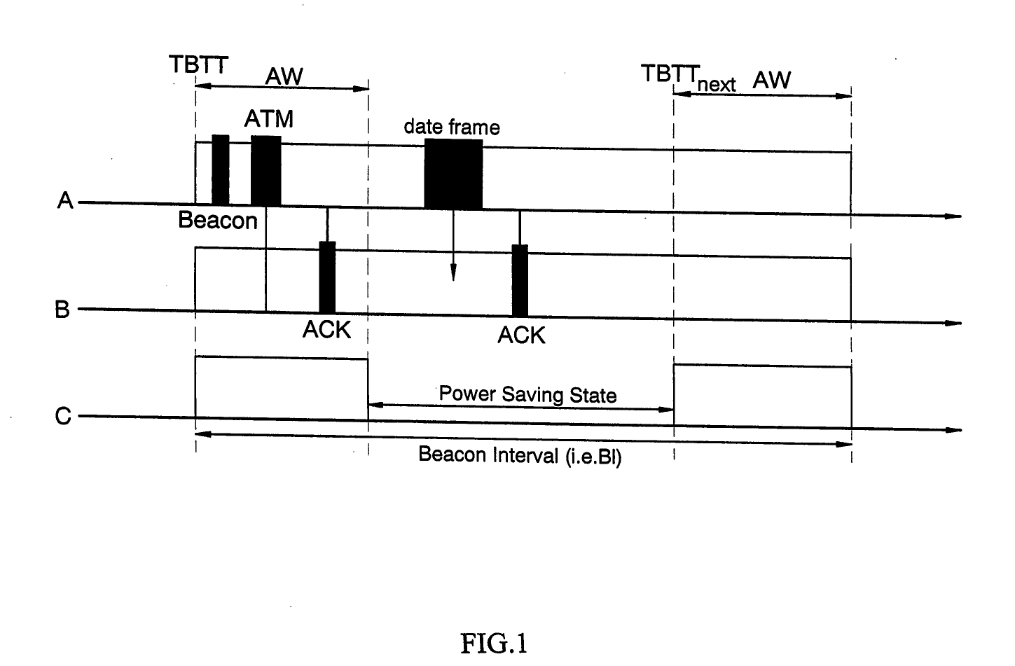

FIG. 1 illustrates an operating example of the IEEE 802.11 power management scheme. Initially, node A, B and C wake up at the beginning of beacon interval. If node C receives no ATIM frame for it during the ATIM window period, it will turn back to doze mode. Once node A having data frames for PS node B, it first transmits an ATIM frame to B during the ATIM window. Node B replies an ATIM ACK to A. after t6he ATIM window, nodes A and B exchange their data frame and ACK using the DCF access procedure. All dozing nodes wake up again at the beginning of next ATIM window. We know that DCF is based on contention-based CSMA/CA mechanism, so it may waste the scarce battery and bandwidth due to frame collisions and lengthen the frame delay due to waiting backoff time.

A good MAC protocol should concern not only throughput but also energy consumption. The proposed protocol realizes the considerations and improves IEEE 802.11 power management MAC protocol. A novel mechanism to schedule those to-be-transmitted data frames after ATIM window and an intelligent mechanism to adjust the size of ATIM window are proposed. Our protocol follows most of IEEE 802.11 regulations such as the structure of a beacon interval and the time synchronization mechanism among all nodes. We describe the detail operations of the two mechanisms in the following two subsections separately.

It is clear that decreasing nodes' backoff idle time and avoiding frame collisions can improve energy efficiency and network throughput. We have found that it can be achieved easily by using the overheading character of the wireless medium and just little modification if IEEE 802.11 power management protocol to have scheduling transmission. In our protocol, a buffered data frame's duration, called working duration, is piggybacked in an ATIM frame. To minimize average waiting time, we follow shortest job first policy basically, so the node with the shortest total working duration has the highest priority to transmit its buffering frames after the ATIM window. The total working duration of a node is the sum of the working durations of all ATIM frames related it. Therefore, each node can easily determine the first transmission PS node in scheduling locally by sorting the total working durations of all PS nodes. The scheduling transmission mechanism is designed for PS nodes to extend their battery lifetime. After PS nodes completing their transmissions, other nodes obey the normal DCF procedure to contend the medium to send their data frames. Moreover, we employ a similar mechanism with [reference 7] which allows a PS node can go back to sleep when it completes all its data transmissions. This is different from IEEE standard that a PS node should keep awake during entire beacon interval even if it has received the data frames before the end of this beacon interval. This mechanism is divided into three phases. We now present the detail operation as follow.

As IEEE 802.11 regulations, all nodes are fully connected and time synchronization so that all PS nodes can wake up at almost the same TBTT. At the TBTT, each node wakes up for an ATIM window interval. If a node with buffering unicast frames to a PS node, it will send an ATIM frame to the PS node within the ATIM window period. On receiving the ATIM frame, the PS node responses an ATIM ACK to the sender of the ATIM frame and completes the reservation of the data frames' transmissions. The information about the sender, receiver, and working duration time of the to-be-transmitted data are contained in ATIM frames denoted as ATIM (Sender_ID, Receiver_ID, working_Duration). Because of the broadcast nature of wireless medium, any other node can overhead the ATIM frame and append to its transmission table as shown in Table 1.

TABLE 1
Transmission Table

| Sender_ID | Receiver_ID | Working_Duration |
|---|---|---|
| A | B | 10 |
| A | C | 20 |
| B | C | 30 |
| D | E | 40 |

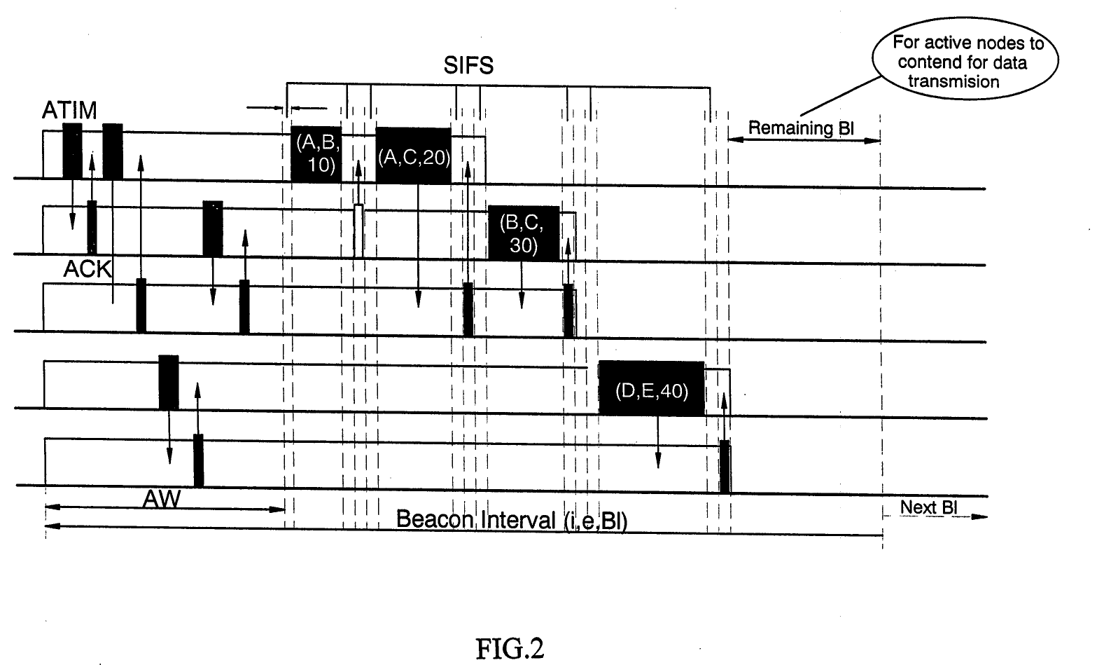

FIG. 2 is an example to illustrate our main idea. To simply our presentation, we omit the beacon transfer procedure which is the same as IEEE 802.11 protocol. There are five PS nodes involved in the ATIM frames' transmissions: A, B, C, D and E. during the ATIM window, only four ATIM frames are announced successfully, i.e., ATIM (A, B, 10), ATIM (A, C, 20), ATIM (B, C, 30) and ATIM (D, E, 40). Therefore, at the end of ATIM window, all nodes in the network should maintain the same transmission table as shown in Table 1 if no transmission error occurs.

To determine the first transmission node, each nod sums up the working durations of individual node in its transmission table. And then the node with minimum total working duration is the first transmission node in the current transmission table. To determine the next transmission node, the related entries of first transmission node will be deleted from transmission table. And then go back to step (a) to determine the next transmission node. The loop of the two steps is performed until the transmission order of all PS nodes is determined.

To illustrate this phase, we also use FIG. 2 as our example. From Table 1, A has two related ATIM frames, ATIM (A, B, 10) and ATIM (A, C, 20), so its total working duration is 10+20=30. B also has two related ATIM frame, ATIM (A, B, 10) and ATIM (B, C, 30), so its total working duration is 10+30=40. The calculations of other nodes are the same as A and B. after calculations, the nodes A, B, C, D and E have the total working duration 30, 40, 50, 40 and 40 respectively. Therefore, node A is the first transmission node because it has the minimum total working duration. To determine the next transmission node, all entries of related A in transmission table are deleted. Table 2 is the new transmission table. From Table 2, we can easily determine the next transmission nodes are B and C. The loop of the two steps is performed until the transmission order of all PS nodes is determined. The final transmission schedule is that after A finishes its transmissions, B, transmits the data frame to C, and D transmits the data frame to E last.

TABLE 2
The new transmission table after the related entries
of node A has been deleted

| Sender_ID | Receiver_ID | Working_Duration |
|---|---|---|
| B | C | 30 |
| D | E | 40 |

At the end of the ATIM window, each PS node exchanges its data frames according to the individual order and the available time specified in the working duration. We continue the scenario as the above example to explain this operation. After ATIM window and a SIFS time, A and B first exchange their frames and A waits for a SIFS time to send the buffering frames to C. while completing the exchange of its traffic, A goes to sleep. In the next transmission, B waits for a SIFS time and then transmits its data frames to C immediately. The next transmission, from node D to node E, follows the same rule as B and C to exchange their frames. At the end of the scheduling transmission time, the nodes not in the transmission table begin to transmit their frames following DCF regulations.

We assume that each node can precisely receive all transmitted ATIM frames from other nodes so that each node in the transmission table would exchange its data frames according to the scheduling order. However, this is not always true for as hoc networks due to the unreliable character of wireless medium and mobility of nodes. To overcome this problem, our protocol provides an error recovery mechanism. We also use the above example to illustrate our main idea. Suppose that node D didn't send its buffering frame to its receiver after the beginning of scheduled transmission time and 2 SIFSs time. The next transmission order node A should find the channel is idle 2 SIFSs time and it concludes that D is fail. To avoid other node's involving and to have good channel utilization, node A starts to send its buffering frames to its receives and node B still follows A to transmit its data frames.

Furthermore, to solve the problem that if some nodes do not overhear all ATIM frames during ATIM window period and they may not have correct transmission table, we can employ the node who sends beacon to send transmission table again after the end of ATIM window to double confirm the transmission order.

It has been mentioned that the ATIM window size affects network performance. To conserve more power of PS nodes and to improve the network throughput, we transform the fixed ATIM window size of IEEE 802.11 protocol into flexible and there is no bound for the ATIM window size at the beginning of the beacon interval. The same as IEEE 802.11 power management protocol, PS nodes wakes up at the beginning of each beacon interval, and the end of the ATIM window depends on the traffic load of ATIM frames. We have two rules to dynamically end the ATIM window size. The detail operation is shown below. The variables/constants used in our presentation are listed in Table 3.

TABLE 3
Meanings of the variables and constants used in
the proposed protocol.

| | |
|---|---|
| T_{SIFS} | time of short inter-frame spacing |
| T_{DIFS} | time of distributed inter-frame spacing |
| T_{ACK} | time to transmit an ACK |
| T_{CW-min} | time of min. contention window |
| T_{Frame} | time to transmit ith data frame in scheduling |
| | table |
| T_{FRAME-min} | time to transmit a min. data frame |
| T_{ATIM} | time to transmit an ATIM frame |
| T_{CURR} | last ATIM frame transmission ending time |
| BI | Beacon Interval |
| TBTT | the beginning time of current BI |
| TBTTₙₑₓₜ | the beginning time of next BI |

During an ATIM window period, all nodes are awake and via overhearing frames they have the same channel information no matter channel is busy or idle. If nodes sense the channel is idle more than T_{DIFS}+T_{Cwmin}, we deem that there will be no other node wanting to send ATIM frames. Accordingly, all nodes end the ATIM window and enter the scheduled transmission phrase. That is
IF Channel IdleTime>=T_{DIFS}+T_{CWmin} THEN
ATIM_WIN=(T_{curr}−TBTT)+T_{DIFS}+T_{CWmin}.

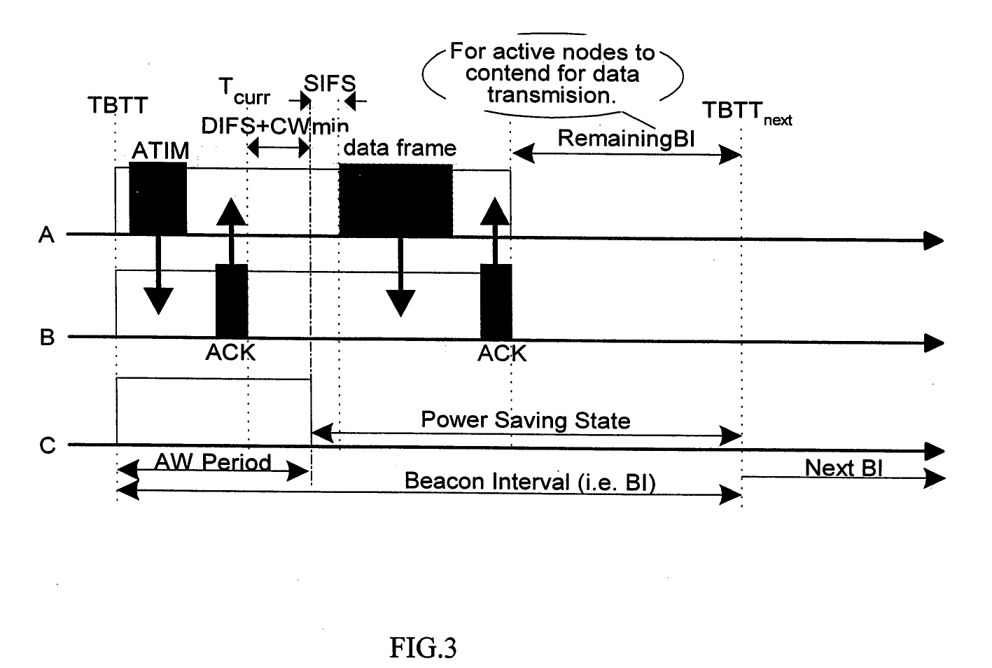

FIG. 3 is an example to illustrate this rule. During ATIM window, there is only one ATIM frame sent from A to B. After they exchange their control frames, the channel becomes idle. Until the idle time lasts for T_{DIFS}+T_{CWmin}, all nodes end the ATIM window and enter the scheduled transmission. According to our scheduling transmission mechanism, A starts to send the data frame to node B, and after SIFS idle time B replies an ACK to node A. after completing their traffic, A and B can turn back to sleep mode. Because node C has nothing to send or receive, it goes to sleep mode at the end of ATIM window. The rest beacon interval is for active nodes to use.

As mentioned above, each node can obtain the duration of frame transmissions by overhearing ATIM frames in a fully connected topology and calculate the total duration of all its currently receiving ATIM frames. If the total duration of the scheduled transmissions reach BI limitation, i.e. there is no any frame can be transmitted in the rest BI even if the shortest frame, all nodes end the current ATIM window immediately and enter the scheduled transmission. That is
Remaining BI=TBTTₙₑₓₜ−T_{curr}−T_{SIFS}−Σ_{(i=1 to n)}(T_{FRAMEi}+T_{SIFS}+T_{ACK})

IF RemainingBI <T_{ATIM}+3T_{SIFS}+T_{FRAMEmin}+2T_{ACK}
THEN ATIM_WIN=T_{curr}−TBTT

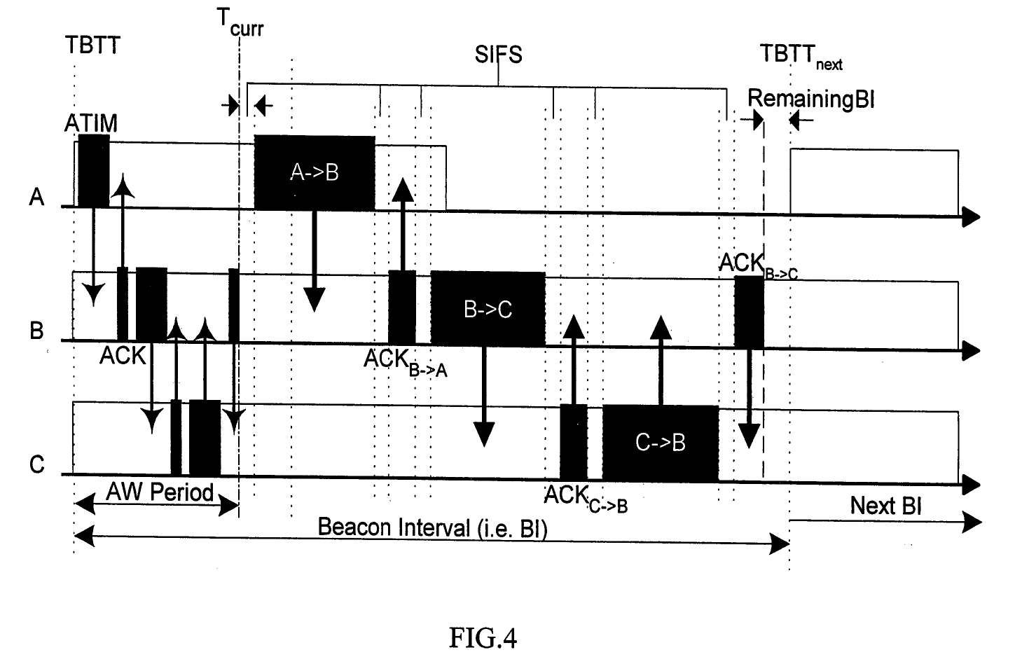

We use FIG. 4 to explain the rule. After the announcements in ATIM period, A, B and C, have the transmission durations of Frame_{A-B}, Frame_{B-C}, and Frame_{C-B}. When they find the remaining beacon interval (i.e. RemainingBI) is less than T_{ATIM}+3T_{SIFS}+T_{FRAMEmin}+2T_{ACK}, it means there in no more time for transmitting the shortest data frame, they the end ATIM window immediately and start to transmit their scheduled data frames after SIFS.

TABLE 4
Energy consumption parameters used in the simulations.

| Parameter | Value |
|---|---|
| transmit | 420 + 1.9 × frame size (μJ) |
| receive | 330 + 0.42 × frame size (μJ) |
| idle | 808 mW |
| doze | 27 mW |

We have developed a simulator to verify the performance of our proposed protocol and compare it with IEEE 802.11 protocol. In our simulation, there are 40 nodes in a WLAN and the transmission rate of each node is 2 Mbits/sec. The number of power saving node is increased from 0 to 40 and the step is 10. the traffic load is following Poisson distribution. In order to make the simulation environment corresponding to a real network, we let the active nodes have higher packets arrival rate than PS nodes. Therefore, the traffic load of active nodes and PS nodes are 6 packets/sec and 1 packet/sec respectively. The destination of each frame is selected randomly from these nodes in the network. The length of beacon interval is 100 ms, the ATIM window size in 802.11 is 5 ms and our protocol with flexible ATIM window size. Table 4, which is referred from [reference 5] based on real experiments on Lucent WaveLAN cards, lists the poser consumption values used in the simulations. Each simulation runs 20 seconds. We have 4 performance metrics, i.e. energy efficiency (Kbyte/Joule), aggregate throughput (Kbyte/sec), ATIM frame collision times, and packets number sending from PS nodes and active nodes.

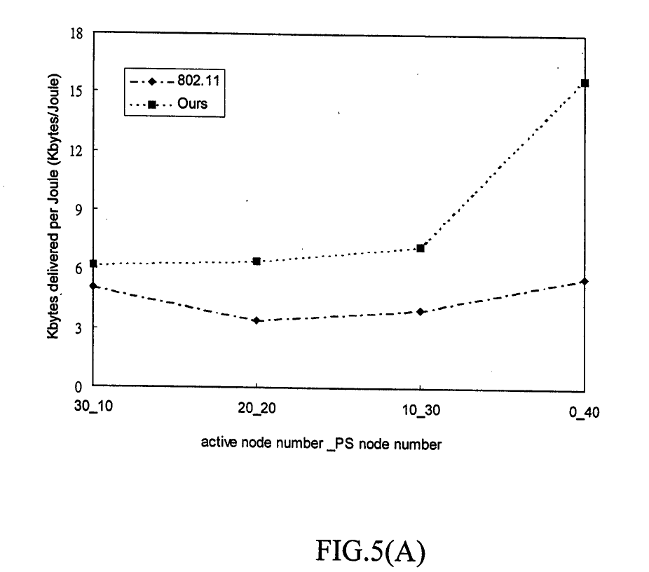

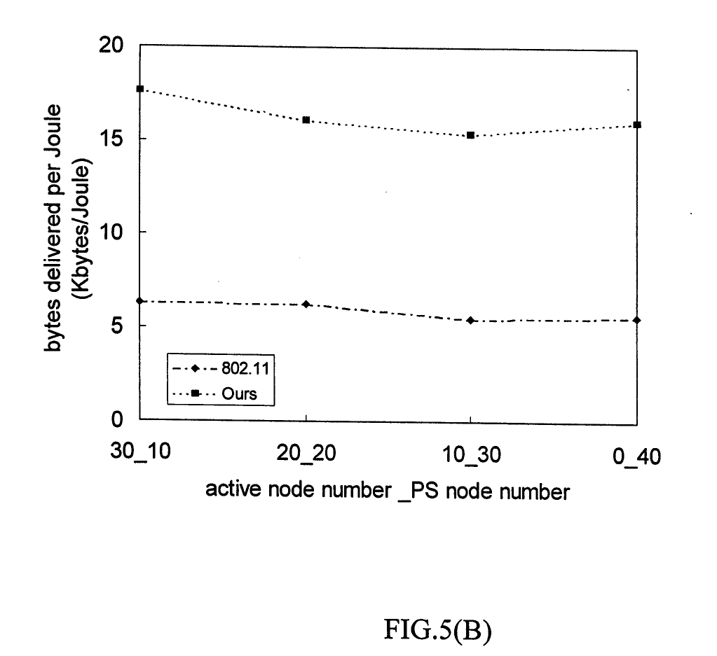

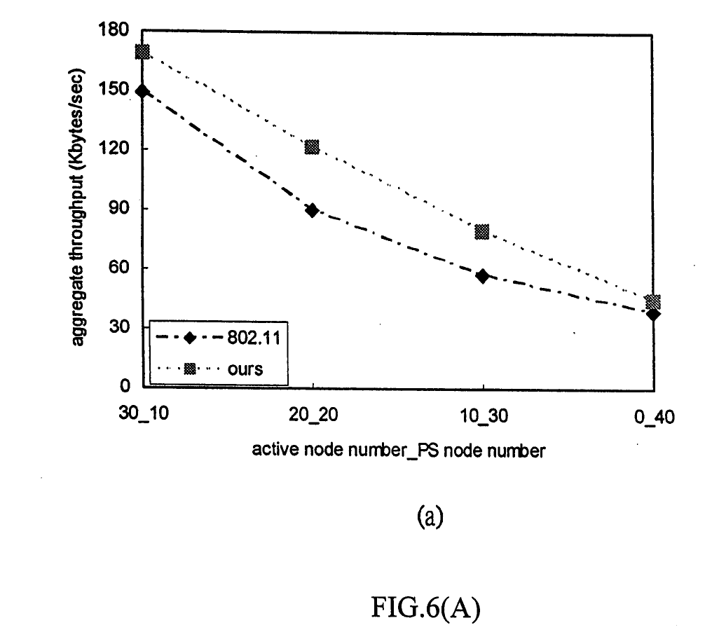

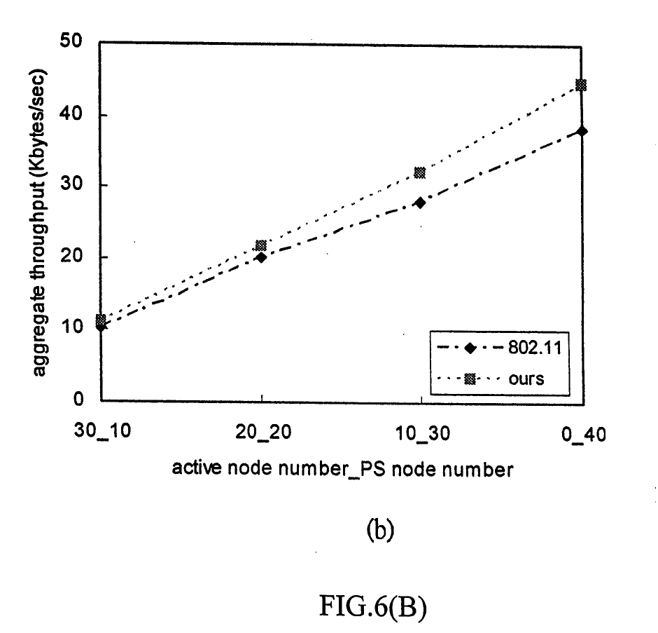

Energy efficiency is shown in FIG. 5 including (a) and (b). FIG. 5(a) is the performance of all the nodes in the network during our simulation time. In order to see the energy efficiency of PS nodes, we have the FIG. 5(b). The curves in both FIG. 5(a) and FIG. 5(b) show that our protocol has better energy efficiency than IEEE 802.11, especially for PS nodes our protocol have almost 5 times energy efficiency than IEEE 802.11. The reasons for the improvement are that we employ the scheduling transmission mechanism to decrease the possibility of frame collision and the energy consumption in idle state and the dynamically adjusting ATIM window to avoid PS nodes keeping awake unnecessary. FIG. 6, including (a) and (B), presents the aggregate through put per second. Similarly, we use FIG. 6(a) and FIG. 6(b) to show the throughput in the simulation time of all the nodes in the network and the PS nodes only respectively. It is obvious that our protocol has better performance than IEEE 802.11 power management protocol. The causes are that PS nodes in our protocol do not need to contend channel after ATIM window and they can surely send their buffering data frames if they have sent ATIM frame successfully in ATIM window period. Thus, our protocol has fewer collisions, less idle time and the more throughput.

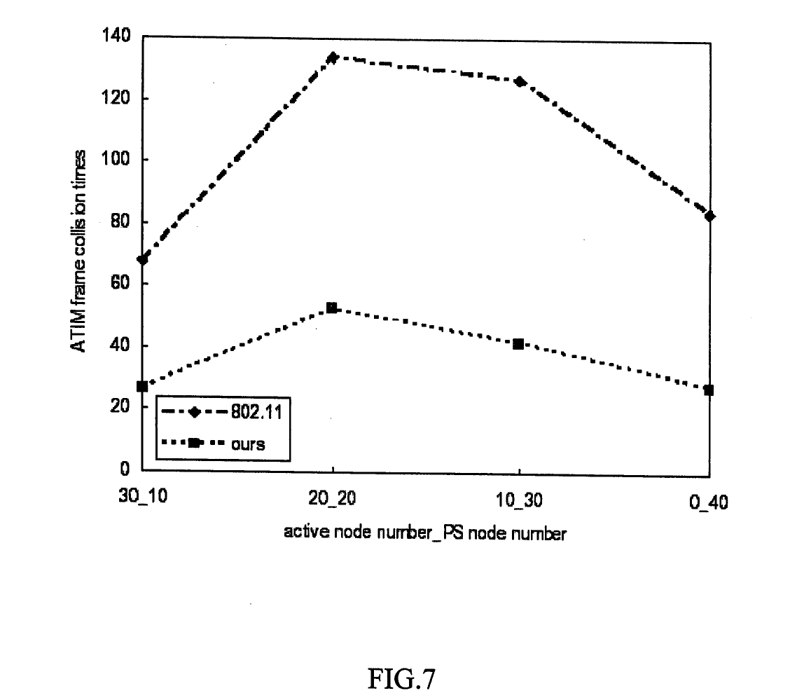

Additionally, to prove that our dynamical ATIM window adjusting strategy does alleviate the collision degree of ATIM frame, we have the ATIM collision times chart in FIG. 7. The result of FIG. 7 shows that our ATIM frame collision time is less than IEEE 802.11's. it is quite reasonable because our protocol adapts dynamical ATIM window adjustment to the variable traffic for PS nodes while IEEE 802.11 employs the fixed ATIM window size no matter how the traffic is.

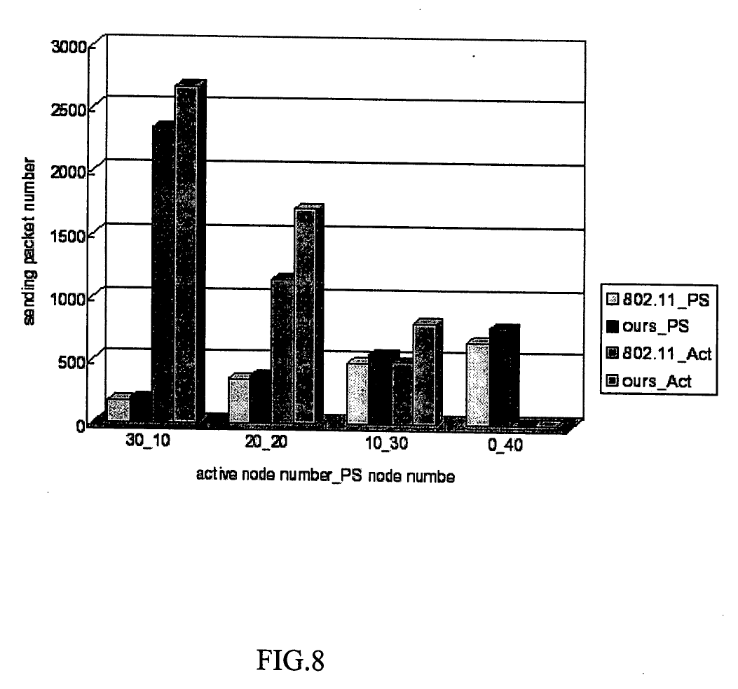

Lastly, FIG. 8 illustrates the packets number sending from PS node and active node. It represents that PS nodes as well as active nodes in the proposed protocol have better performance than IEEE 802.11 power management protocol. Combining the result of FIG. 6, FIG. 7 and FIG. 8, we can demonstrate that our protocol also has less packet delay which is important design issue for an QoS-based networks.

From all simulation results, our protocol does outperform not only more energy efficiency but also better throughput than IEEE 802.11 power management protocol.

We have developed a new energy efficient MAC protocol for ad hoc WLANs. The proposed protocol has two main contributions. First to avoid unnecessary frame collisions and backoff waiting time in data frame transmissions, we design a novel scheduling mechanism for nodes to transmit their frames to power saving nodes in order. Second, to more conserve the power of PS nodes and improve to the channel utilization, we develop an intelligent strategy to dynamically shorten the ATIM window size. The simulation result prove that our energy efficient MAC protocol have a batter performance than IEEE 802.11 power management protocol not only in aggregate throughput but also in energy efficiency.

Although the invention has been explained in relation to its preferred embodiment, it is to be understood that many other possible modifications and variations can be made without departing from the spirit and scope of the invention as hereinafter claimed.

### REFERENCES

[1] S. Agrawal and S. singh. “An experimental stud of TCP's energy consumption over wireless link.” 4^{th} European Personal Mobile Communications Conference, pp. 181-190, February 2001.

[2] I. Chakraborty, A. Kashyap, A. Kumar, A. Rastogi, H. Saran, and R. Shorey. “MAC Scheduling Policies with Reduced Power Consumption and Bounded Packet Delay for Centrally Controlled TDD Wireless Networks.” IEEE Int'l Conference on communications, Vol. 7, pp. 1980-1984, June 2001.

[3] Z.-T. Chou, S.-L. Wu, P.-C. Tseng, and C.-C. Hsu, “Energy-efficient Power Management Protocols for Multi-hop Ad Hoc Wireless Networks”, Int'l Symposium on Communications, December 2003.

[4] L. M. Feeney and M. Nilsson. “Investibating the Energy Consumption of a Wireless Network Interface in an Ad Hoc Networking Environment.” IEEE INFOCOM, Vol.3, pp. 1548-1557, April 2001.

[5] L. M. Feeney. “An Energy Consumption Model for Performance Analysis of Routing Protocols for Mobile Ad Hoc Networks.” ACM/Kluwer Mobile Networks and Applications, Vol.6, No. 3, pp. 239-249, 2001.

[6] C.-S. Hsu, J.-P. Sheu, and Y-C. Yseng. “Minimize Waiting Time and Conserve Energy by Scheduling Transmissions in IEEE 802.11-based Ad Hoc Networks.” Int'l Conf. On Telecommunications, pp. 393-399, February 2003.

[7] E.-S. Jung and N. H. Vaidya. “An Efficient MAC Protocol for Wireless LANs.” IEEE INFOCOM, Vol. 3, pp. 1756-1764, June 2002.

[8] R. Krashinsky and H. Balakrishnan, “Minimizing Energy for Wireless Web Access with Bounded slowdown.” ACM MOBICOM, pp. 119-130, September 2002.

[9] R. Kravets and P. Krishnan. “Application-driven Power Management for Mobile Communication.” ACM/URSI/Baltzer Wireless Networks (WINER), Vol. 6, No. 4, pp. 263-277, July 2000.

[10] S.-C. Lo, G Lee, and W.-T. Chen. “An Efficient Multi-polling Mechanism for IEEE 802.11 Wireless LANs.” IEEE TRANSACTIONS ON COMPUTERS, Vol. 52, No. 6, pp. 764-778, June 2003.

[11] J. H. Ryu and D. H. Cho. “A Power-Saving Multi-cast Routing Scheme in 2-tir Hierarchical Mobile Ad-Hoc Networks.” Proc. Of IEEE Vehicular Technology Conference, Vol. 4, pp. 1974-1722, 2000.

[12] S. Singh, M. Woo, and C. S. Raghavendra. “Power-Aware Routing in Mobile Ad Hoc Networks.” ACMMOBICOM, pp.181-190, October 1998.

[13] J. A. Stine and Gustavo de Veciana. “Improving Energy Efficiency of Centrally Controlled Wireless Data Networks.” ACM/Baltzer Wireless networks, Vol. 8, pp. 681-700, 2002.

[14] Y-C. Tseng, C.-S. Hsu, and T.-Y Hsieh. “Power-Saving Protocol for IEEE 802.11-Based Multi-Hop Ad Hoc Networks.” IEEE INFOCOM, Vol. 1, pp. 23-27, June 2002.

[15] H. Woesner, J.-P. Ebert, M. Schlager, and A. Wolisz. “Power-Saving Mechanism in Emerging Standards for Wireless LANs: The MAC Level perspective.” IEEE Personal Communications, Vol. 5, pp. 40-48, June 1998.

[16] IEEE Std 802.11-1999, Wireless LAN Medium Access Control (MAC) and Physical Layer (PHY) Specifications. LAN MAN Stndards Committee of the IEEE Computer Society, IEEE, November 1999.

[17] M. Zorzi and Ramesh R. Rao. IS TCP energy efficient? Proc. IEEE MoMuC, pp. 198-201, November 1999.

What is claimed is:

1. An energy efficient medium access control protocol for IEEE 802.11 WLANs scheduling a delivery of each of power saving host for reducing waiting time and a collision between the transmitting data and making each awake host overhear the transmitting data one another for adjusting an announcement traffic indication message (ATIM) window size by using characters of fully connected of wireless LAN topology.

2. The energy efficient medium access control protocol as claimed in claim 1, wherein scheduling a delivery comprises the following steps: establishing a transmit list, determining a sequence of transmission and transmitting the data frames.

3. The energy efficient medium access control protocol as claimed in claim 1, wherein adjusting an announcement traffic indication message further saves power under a efficient condition and promote the throughput of networks and increased channel utilization, and transforms the original medium access control protocol for IEEE 802.11 to be changeable and determines the ATIM window size due to the flow on the networks.

4. The energy efficient medium access control protocol as claimed in claim 2, wherein adjusting an announcement traffic indication message further saves power under a efficient condition and promote the throughput of networks and increased channel utilization, and transforms the original medium access control protocol for IEEE 802.11 to be changeable and determines the ATIM window size due to the flow on the networks.
